(19) United States
(12) Patent Application Publication
(10) Pub. No.: US 2006/0197251 A1
(43) Pub. Date: Sep. 7, 2006

(54) Mold for forming airbag cover, method for forming airbag cover, and airbag cover

(75) Inventor: Masami Sawada, Tokyo (JP)

Correspondence Address: KANESAKA BERNER AND PARTNERS LLP, SUITE 300, 1700 DIAGONAL RD, ALEXANDRIA, VA, 22314-2848, US

(73) Assignee: TAKATA CORPORATION, Tokyo (JP)

(21) Appl. No.: 11/347,276

(22) Filed: Feb. 6, 2006

(30) Foreign Application Priority Data
Mar. 7, 2005 (JP) 2005-062551

(51) Int. Cl. B28B 7/14

(52) U.S. Cl. 264/163; 425/577

(57) ABSTRACT

An airbag cover mold includes a core member and a cavity member, and a resin material is supplied to a cavity between the core member and the cavity member. The core member has a plate-shaped blade block that functions as a protruding piece for forming a tear line. The blade block has openings for allowing the resin material to flow from one side of the blade block to the other side. An edged portion is provided at the top edge of each opening so as to point downward. Injection of the resin material is started after the blade block is moved to the cavity. After the injection, the blade block is moved outward to form the tear line. The mold provides an airbag cover in which smoothness in a region around a tear line is ensured.

### BACKGROUND OF THE INVENTION AND RELATED ART STATEMENT

The present invention relates to a mold for forming an airbag cover having a tear line, a method for forming an airbag cover using the mold, and an airbag cover formed by this method. The airbag cover may be, for example, a module cover of an airbag device, an inner panel of an instrument panel or the like, having an airbag and an inflator therebehind.

An airbag cover having a tear line along which the airbag cover breaks when an airbag is inflated is known in the art. Japanese Unexamined Patent Application Publication No. 9-240412 illustrates a method for forming such an airbag cover having a tear line (see prior art reference FIG. 9). According to this method, a plate-shaped member is disposed so as to project into a cavity from the inside of the mold so that the tear line is formed by this plate-shaped member. The plate-shaped member has an opening for allowing a resin material to flow therethrough. According to the aforementioned publication, as described in paragraph 0026, the plate-shaped member is moved outward in the mold when an expanding/hardening process reaches a certain stage or when the expanding/hardening process is finished.

In the plate-shaped member of the mold according to the above-mentioned Japanese Unexamined Patent Application Publication No. 9-240412, the opening for allowing the resin material to flow therethrough is simply a through hole. Therefore, when the plate-shaped member is moved outward after the expanding/hardening process reaches a certain stage, a resin forming body (hardened body) disposed in the opening is roughly cut by the plate-shaped member. As a result, the smoothness in the region around the tear line formed in the airbag cover is degraded.

It is an object of the present invention to solve the above-described problem and to provide a method and a mold for forming an airbag cover in which the smoothness in a region around a tear line is ensured, and to provide an airbag cover formed by this method.

Further objects and advantages of the invention will be apparent from the following description of the invention and the associated drawings.

### SUMMARY OF THE INVENTION

A mold for forming an airbag cover according to one embodiment of the invention includes a protruding piece for forming a tear line. The protruding piece is capable of moving inward and outward so as to project into a cavity from an inner surface of the mold. The protruding piece has an opening that passes therethrough and allows a resin material to flow from one side of the protruding piece to the other side of the protruding piece in the cavity. An edged portion is provided at a back edge of the opening in a direction in which the protruding piece moves outward.

According to another aspect of the invention, in the mold for forming the airbag cover, the edged portion points toward a front edge of the opening in the direction in which the protruding piece moves outward.

According to another aspect of the invention, in the mold for forming the airbag cover, the protruding piece is plate shaped and extends in an extending direction of the tear line. In addition, the protruding piece has a plurality of the aforementioned openings. The openings are arranged along the extending direction of the protruding piece at intervals. There is at least one recess in a front edge of the protruding piece in a direction in which the protruding piece moves inward. The recess is positioned between the adjacent openings, and allows the resin material to flow from one side of the protruding piece to the other side of the protruding piece.

According to another aspect of the invention, in the mold for forming the airbag cover, the size of the cavity in the moving direction of the protruding piece in a region near the protruding piece is increased toward the protruding piece.

The invention is also directed to a method for forming an airbag cover that includes the step of forming the airbag cover using the above-described mold.

The invention is also directed to an airbag cover formed by the above-described method.

In the mold for forming the airbag cover and the method for forming the airbag cover according to the present invention, the opening formed in the protruding piece allows the resin material to flow from one side of the protruding piece to the other side thereof when the resin material is supplied to the mold.

According to the present invention, the edged portion is provided at the back edge of the opening in the direction in which the protruding piece moves outward. When the protruding piece is moved outward, the resin forming body (hardened resin) disposed in the opening is cut by the edged portion. Accordingly, the cut surfaces are smooth, and smoothness in the region around the tear line is ensured.

When the edged portion points toward the front edge of the opening in the direction in which the protruding piece moves outward, the smoothness of the cut surfaces of the resin forming body is increased.

In addition, when the protruding piece has at least one recess in the front edge of the protruding piece in the direction in which the protruding piece moves inward, the recess being positioned between the adjacent openings and allowing the resin material to flow from one side of the protruding piece to the other side thereof, the resin material also flows through the recess when the resin material is supplied to the mold. Accordingly, the entire region of the cavity can be evenly filled with the resin material.

According to the present invention, when the size of the cavity in the moving direction of the protruding piece in a region near the protruding piece is increased toward the protruding piece, the flow resistance generated when the resin material flows near the protruding piece can be further reduced.

### BRIEF DESCRIPTION OF THE DRAWINGS

FIG. 1 illustrates an airbag cover formed by a mold according to one embodiment of the invention, wherein FIG. 1a shows a front view, FIG. 1b shows a sectional view of FIG. 1a and FIG. 1d taken along line 1b-1b, FIG. 1c shows a sectional view of FIG. 1d taken along line 1c-1c, and FIG. 1d is a sectional view of FIG. 1b and FIG. 1c taken along line 1d-1d.

FIG. 2 is a sectional view of a portion of the mold around a tear line.

FIG. 3 is a perspective view of a blade block that functions as a protruding piece.

FIGS. 4a and 4b are sectional views illustrating a forming method.

### DETAILED DESCRIPTION OF THE PREFERRED EMBODIMENTS

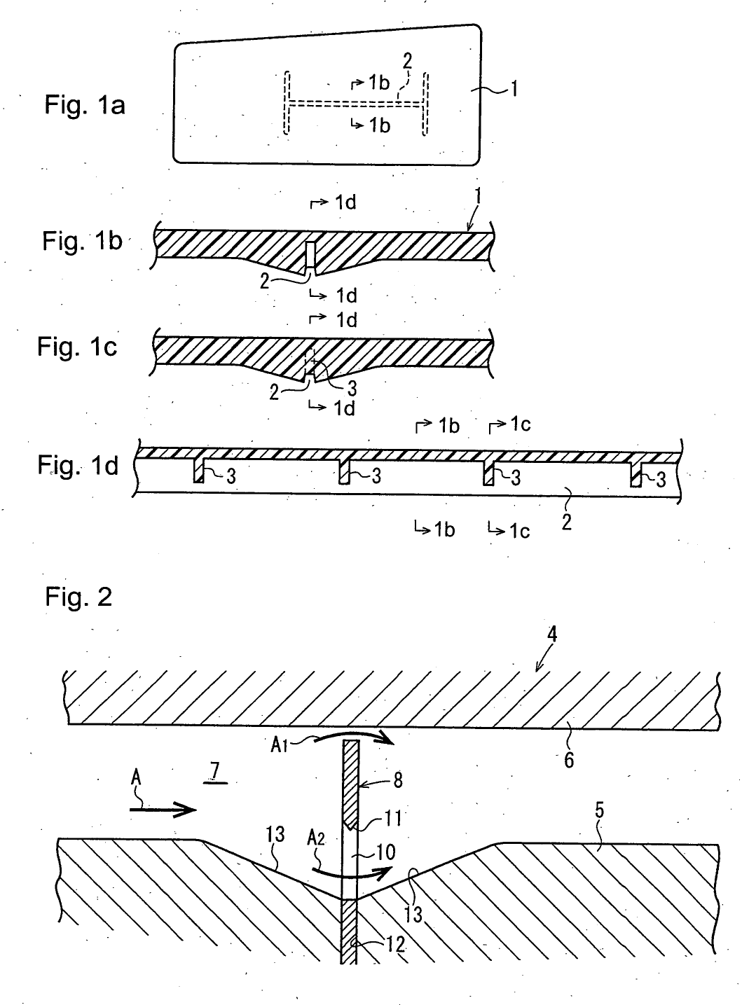

An embodiment of the present invention will be described below with reference to the accompanying drawings. FIG. 1 illustrates an airbag cover formed by a mold according to the embodiment, wherein FIG. 1a shows a front view, FIG. 1b shows a sectional view of FIG. 1a and FIG. 1d taken along line 1b-1b, FIG. 1c shows a sectional view of FIG. 1d taken along line 1c-1c, and FIG. 1d is a sectional view of FIG. 1b and FIG. 1c taken along line 1d-1d.

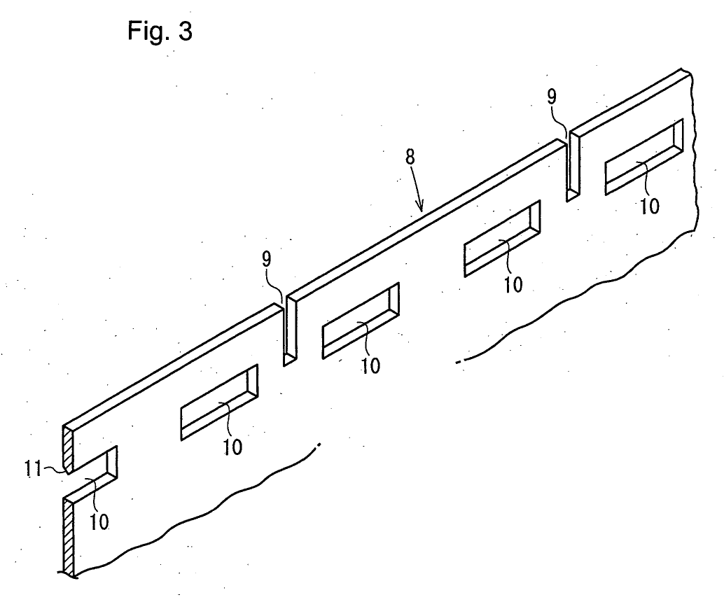

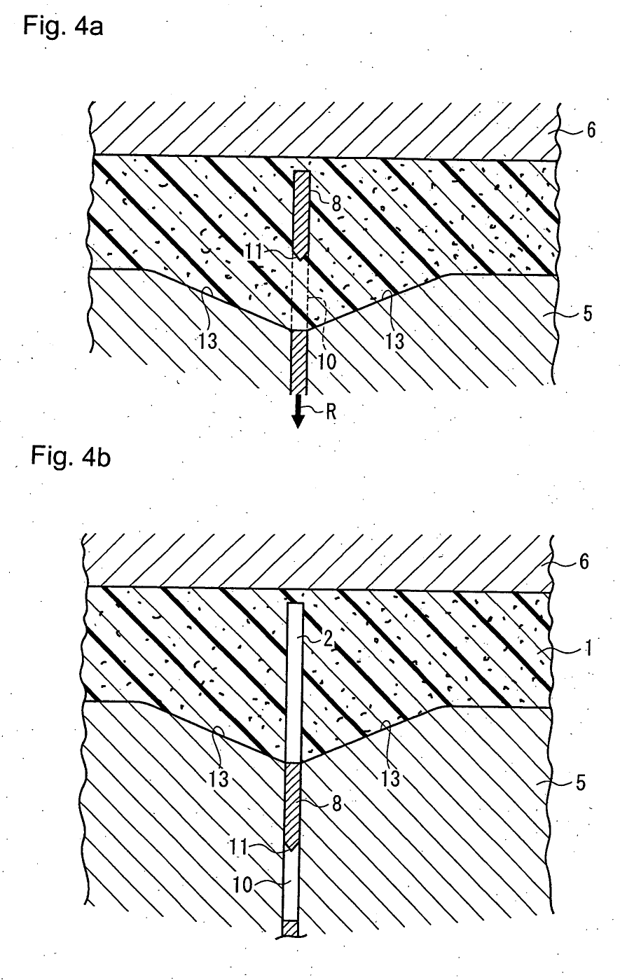

FIG. 2 is a sectional view of a portion of the mold around a tear line, and FIG. 3 is a perspective view of a blade block that functions as a protruding piece. FIGS. 4a and 4b are sectional views illustrating a forming method.

In this embodiment, an airbag cover 1 functions as a module cover for a passenger airbag device. A tear line 2 is formed in the airbag cover 1. The tear line 2 includes a groove that extends along a back surface of the airbag cover 1. In this embodiment, the tear line 2 has an “H” shape, as shown in FIG. 1a. However, the tear line 2 may also have a bracket shape, an angular “8” shape, etc. In this embodiment, bridge portions 3 that connect the opposing sides of the tear line 2 are provided. The bridge portions 3 are formed as shallow regions in the tear line 2.

A mold 4 for forming the airbag cover 1 includes a core member 5 and a cavity member 6. A resin material is supplied to a cavity 7 between the core member 5 and the cavity member 6, and is taken out from the mold 4 after a hardening step so as to form the airbag cover 1.

The core member 5 has a plate-shaped (i.e., rectangular-shaped) blade block 8 that functions as a protruding piece for forming the tear line 2. The blade block 8 has recesses 9 for forming the above-described bridge portions 3.

The blade block 8 also has openings 10 for allowing the resin material to flow from one side of the blade block 8 to the other side, for example, along the arrow A₂ in FIG. 2. An edged (i.e., pointed) portion 11 is provided at the top edge of each opening 10 in the figure so as to point downward.

The blade block 8 is inserted into a blade-block storing slit 12 formed in the core member 5. Although not shown in the figure, the blade block 8 is connected to a cylinder device with a shaft, and can move inward and outward in the vertical direction in the figure.

In this embodiment, when the blade block 8 is moved outward to the limit, the inner edge of the blade block 8 is flush with the inner surface of the core member 5, as shown in FIG. 4b. In addition, when the blade block 8 is moved inward to the limit, a predetermined gap is provided between the inner edge of the blade block 8 and the cavity member 6, as shown in FIGS. 2 and 4a. In this embodiment, when the blade block 8 is moved inward to the limit, the bottom edge of each opening 10 is flush with the inner surface of the core member 5.

In this embodiment, the core member 5 has inclined surfaces 13 in a region near the blade block 8, the inclined surfaces 13 being inclined such that the size of the cavity 7 (distance between the inner surface of the core member 5 and the inner surface of the cavity member 6) is increased toward the blade block 8. Since the inclined surfaces 13 are provided, the vertical width of the openings 10 is increased and the flow resistance of the resin material from one side of the blade block 8 to the other side is reduced.

The width of the inclined surfaces 13 (width in the direction perpendicular to the blade block 8) is preferably about 3 mm to 10 mm, and more preferably, about 4 mm to 7 mm. In addition, the inclination angle of the inclined surfaces 13 is preferably about 10° to 30°, and more preferably about 15° to 25°.

In a process of forming the airbag cover 1 using the mold 4, injection of the resin material is started after the blade block 8 is moved inward to the limit thereof. A part of the injected resin material travels toward the blade block 8 and tries to pass the blade block 8 as shown by the arrows in FIG. 2. More specifically, since the blade block 8 has the openings 10 and the recesses 9, a part of the resin material that travels along the arrow A flows through the openings 10 to the other side of the blade block 8, as shown by the arrow A₂. The remaining part of the resin material flows through a region above the blade block 8 or the recesses 9 to the other side of the blade block 8, as shown by the arrow A₁.

Thus, the resin material flows from one side of the blade block 8 to the other side thereof not only via the flow A₁ between the blade block 8 and the cavity member 6 but also via the flow A₂ through the openings 10 and the flow through the recesses 9. Accordingly, the flow resistance of the resin material is reduced. In addition, the flow resistance of the resin material is also reduced since the inclined surfaces 13 are provided so as to increase the cavity size in a region around the blade block 8, as described above.

Accordingly, the injected resin material can smoothly pass the blade block 8 and the cavity 7 is evenly filled with the resin material. Therefore, defects like sink marks, deformations, and swellings can be prevented from being formed on the airbag cover 1 due to the turbulent flow of resin, nonuniform density, residual stress, etc.

After the injection of the resin material, the blade block 8 is moved outward to the limit to form the tear line 2. Then, the airbag cover 1 is taken out of the mold 4. Since the blade block 8 has the edged portion 11 in each opening 10, the hardened body of resin material disposed in each opening 10 can be cut smoothly. Accordingly, a smooth tear line 2 can be obtained.

The above-described embodiment is simply one example in which the present invention is applied, and the present invention also allows embodiments other than that illustrated in the drawings. For example, although the module cover for the passenger airbag device is described in the above-described embodiment, a module cover for a driver airbag device or an instrument panel may also be formed. In addition, the present invention may also be applied to a process of forming an interior panel, such as a door trim panel, for attaching a side airbag device.

The disclosure of Japanese Patent Application No. 2005-062551 filed on Mar. 7, 2005, is incorporated herein.

What is claimed is:

1. A mold for forming an airbag cover, comprising:
a cavity within the mold, for receiving a resin material to be molded;
a protruding piece for forming a tear line in the airbag cover, said protruding piece capable of being moved inward so as to project into the cavity from an inner surface of the mold and of being moved outward so as to withdraw from the cavity, said protruding piece having an opening passing therethrough for allowing the resin material to flow from one side of the protruding piece to the other side of the protruding piece, and
a pointed portion provided at an edge of the opening opposite the inner surface of the mold.

2. The mold according to claim 1, wherein the pointed portion points toward the inner surface of the mold.

3. The mold according to claim 1, wherein the protruding piece has a plate shape and extends in an extending direction of the tear line,
the protruding piece comprises a plurality of the openings, the openings being arranged at intervals along the extending direction of the protruding piece, and
the protruding piece has at least one recess in an edge of the protruding piece opposite the inner surface of the mold, the recess being positioned between the adjacent openings for allowing the resin material to flow from one side of the protruding piece to the other side of the protruding piece.

4. The mold according to claim 1, wherein the inner surface of the mold has inclined surfaces adjacent to the protruding piece such that the size of the cavity is increased toward the protruding piece.

5. The mold according to claim 4, wherein a width of each of the inclined surfaces in a direction perpendicular to a plane of the protruding piece is from about 3 mm to about 10 mm.

6. The mold according to claim 4, wherein an inclination angle of the inclined surfaces is from about 10° to about 30°.

7. The mold according to claim 4, further comprising a flat cavity member, and a core member, for forming the cavity together with the cavity member, having said inner surface, said protruding piece protruding into the cavity through the core member.

8. A method of forming an airbag cover from a mold, comprising:
arranging a mold comprising a cavity for receiving a resin material to be molded, and a protruding piece for forming a tear line in the airbag cover, the protruding piece comprising an opening passing therethrough for allowing the resin material to flow from one side of the protruding piece to the other side of the protruding piece, and a pointed portion provided at an edge of the opening opposite an inner surface of the mold;
moving the protruding piece inward so as to project into the cavity from the inner surface of the mold;
providing the resin material to the mold; and
moving the protruding piece outward so as to withdraw from the cavity and thereby provide the molded airbag cover.

9. The method of forming an airbag cover according to claim 8, wherein resin disposed in the opening is cut by the pointed portion as the protruding piece is moved outward.

10. An airbag cover formed by the method according to claim 8.
